(19) United States
(12) Patent Application Publication
(10) Pub. No.: US 2014/0175757 A1
(43) Pub. Date: Jun. 26, 2014

(54) SHAFT SEAL WITH RETENTION FEATURES AND OVERMOLDED SEAL COMPONENT

(71) Applicant: Parker-Hannifin Corporation, Cleveland, OH (US)

(72) Inventors: Berndt L. Luchs, Rustburg, VA (US); Max Ellison, Lynchburg, VA (US)

(21) Appl. No.: 14/104,090

(22) Filed: Dec. 12, 2013

Related U.S. Application Data
(60) Provisional application No. 61/845,016, filed on Jul. 11, 2013.
(60) Provisional application No. 61/740,786, filed on Dec. 21, 2012.

(51) Int. Cl. F16J 15/32

(52) U.S. Cl. CPC F16J 15/3232
USPC 277/562; 277/500

(57) ABSTRACT

A seal component for a shaft seal assembly includes an elastomeric element and a substrate, wherein the seal component has an over-molded configuration in which the elastomeric element is over-molded onto the substrate. In one embodiment, the elastomeric element includes a pair of flexible arms that are compressible about an apex to energize the seal component. In another embodiment, the shaft seal assembly includes twist lock retention features for retaining the seal component within the housing structure. The seal component includes a plurality of locking features, and a plurality of cooperating locking slots is provided in the housing structure that respectively receive the locking features of the seal component. Specifically, when the seal component is rotated relative to the housing structure from an initial position to a second locked position, the locking features are compressed within the locking slots of the housing structure in the second locked position.

### FIELD OF THE INVENTION

The present invention is directed to a seal for a shaft seal assembly configured for use in conjunction with bore housing seal assemblies, and particularly to a shaft seal with an over-molded seal component and enhanced retention features for retaining the seal material to a bore housing.

### BACKGROUND OF THE INVENTION

Various shaft sealing applications are provided in extreme environments of high pressure, temperature extremes, rotational and other exertion forces, and the like. Examples of such environments include automotive and light truck automatic transmission and engine systems, in which shaft seals are used for front crank assemblies and covers, cam-lock structures, and other applications.

Conventional shaft seal assemblies may extend circumferentially substantially to form a ring structure. The shaft seal assembly may include a housing structure against which is inserted a seal component. The housing structure typically is a rigid or semi-rigid material, such as a rigid or semi-rigid molded plastic or metal material. For applications of the type referenced above, nylon-based plastics materials are now common. The housing structure includes a bore that constitutes a recessed area or surface in which the seal rests.

Conventional shaft seal assemblies further include a seal component having an elastomeric element formed about a substrate. The elastomeric element generally provides flexibility to the seal so the seal may be compressed and energized to form a tight seal within the bore of the housing structure. The substrate is formed of a more rigid material, such as a rigid or semi-rigid plastic or metal (steel for example) that acts as a stiffener element for controlling in part the degree of compressibility of the surrounding elastomeric element. In conventional configurations, the elastomeric element essentially is formed around the substrate or with the substrate substantially embedded within the elastomeric material. Such configuration, however, has proven to be deficient for certain shaft seal usages.

The seal component typically is held in place within the bore of the housing structure by frictional forces against the surface of the bore. It has proven deficient, however, to rely merely on such frictional forces for proper retention of the seal component. In typical shaft seal applications, particularly utilizing plastic application housings, the housing structures may have extreme dimensional tolerances, which results in there being a significant variation in bore diameters of the housing structure. An effective seal component, therefore, must be effective across such tolerances of varying range of bore diameters. Accordingly, seals that rely on frictional forces alone have often been deficient in maintaining an adequate seal.

To overcome such deficiencies regarding retention of the seal component, shaft seal assemblies have been developed that attempt to provide enhanced retention features. In a typical conventional design, the housing structure that defines the bore further includes an undercut further machined into the housing structure adjacent the bore. In addition, the seal component may include an extended rib that is inserted into the undercut.

FIG. 1 is a schematic diagram depicting a perspective view of a portion of a conventional shaft seal assembly 10 that exemplifies this conventional approach to enhanced retention. Specifically, in the seal assembly 10, a housing structure 12 cooperates with a seal component 14, the seal component 14 including an elastomeric element 20 formed about a substrate 22. The seal component 14 has an outer diameter 24 onto which there are formed a plurality of rib structures 26. The seal component 14 is held in place within bore 16 in part by frictional forces of the rib structures 26 against the surface of the bore 16. The housing structure 12 further includes an undercut 32 further machined into the housing structure 12 adjacent the bore 16. In addition, the seal component 14, in addition to the rib structures 26, further includes an extended rib 34 that is inserted into the undercut 32.

By providing the undercut 32 that receives the extended rib 34, enhanced retention is achieved. However, there are significant drawbacks to such configuration. The machining process for adding the undercut 32 adjacent the bore 16 is a delicate operation that adds significant effort and expense to the manufacture of the housing structure. Particularly for plastic housings and in relation to typical shaft seal applications, simple molding of the undercut generally is not an option to the configuration of the undercut, and thus the referenced machining must be performed precisely as to each housing structure. Accordingly, although the configuration of FIG. 1 may enhance seal retention, the configuration remains an undesirable solution due to the added complexity of manufacture.

### SUMMARY OF THE INVENTION

The present invention provides improved retention of shaft seal components and assemblies for use in applications involving high rotational forces, and extremes of temperature and pressure. The shaft seal components and assemblies of the present invention provide an improved structure of a seal component, including an elastomeric element over-molded on a substrate structure. The shaft seal components and assemblies further provide enhanced seal retention without requiring complex machining of undercuts in the housing structure as compared to conventional configurations, while maintaining an effective seal in the associated applications.

Accordingly, an exemplary seal component including an elastomeric element over-molded onto a substrate material is described. The elastomeric material may have a recess for receiving an extension of a substrate material, and during the over-molding process, a chemical bond is formed between the recess of the elastomeric element and the extension of the substrate material. A shaft seal assembly is formed including the described seal component and a shaft seal housing structure. The seal component is energized to provide a seal against a bore of the housing structure. Retention features aid in holding the seal component within the housing structure adjacent the bore.

A shaft seal assembly including an over-molded seal component with a twist lock bore retention feature also is described. In an exemplary embodiment, the shaft seal assembly includes twist lock retention features for retaining the seal component within the housing structure. In the twist lock retention embodiment, a plurality of locking features is molded onto an axial face of the seal component. A plurality of cooperating locking slots or bores is provided in the housing structure, and the locking slots of the housing structure receive the locking features of the seal component. Specifically, the dimensions of each locking slot vary from a first end to a second end, and in particular the spatial dimension or width of each locking slot is smaller toward the second end as compared to the first end. In assembling the shaft seal assembly, the seal component is joined to the housing structure such that the locking features of the seal component initially are inserted into the first wider ends of the respective locking slots. The seal component is then twisted, i.e., rotated, relative to the housing structure until the locking features of the seal component are located within the second smaller-width ends of the respective locking slots of the housing structure. Because of the smaller dimensional width of the second ends of the locking slots, the twisting action causes the locking features to compress and energize within such second ends, resulting in a tight fit of the locking features within the second ends of the respective locking slots. In this manner, the twist lock features provide for enhanced seal retention, but do not require the additional machining of an undercut into the internal bore of the housing structure to retain the seal component.

In accordance with such features, an aspect of the invention is a seal component for a shaft seal assembly. In exemplary embodiments, the seal component includes an elastomeric element and a substrate. The seal component has an over-molded configuration in which the elastomeric element is over-molded onto the substrate. Another aspect of the invention is a shaft seal assembly. Exemplary embodiments of the shaft seal assembly include the described seal component including the over-molded configuration, and a housing structure that houses the seal component.

Another aspect of the invention is a second seal component for a shaft seal assembly. Embodiments of the second seal component include an elastomeric element that has a plurality of twist lock retention locking features configured to be received in a portion of a housing structure of the shaft seal assembly. When the seal component is rotated relative to the housing structure from an initial position to a second locked position, the locking features are retained within the receiving portions of the housing structure in the second locked position.

Another aspect of the invention is a second shaft seal assembly. Embodiments of the second shaft seal assembly include the described seal component including the twist lock retention locking features and a housing structure. The locking features are configured to be received in a portion of the housing structure in an initial position and second locked position, and when the seal component is rotated relative to the housing structure from the initial position to the second locked position, the locking features are retained within the receiving portions of the housing structure in the second locked position.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a schematic diagram depicting a perspective view of a portion of a conventional shaft seal assembly having an undercut bore.

FIG. 2 is a schematic diagram depicting a perspective view of a portion of a seal component for use in a shaft seal assembly with an over-molded configuration.

FIG. 3 is a schematic diagram depicting a perspective cross-sectional view of a portion of a seal component of FIG. 2 identified by the oval A.

FIG. 4 is a schematic diagram depicting a perspective cross-sectional view of a portion of a seal component of FIG. 2 identified by the oval B.

FIG. 5 is a schematic diagram depicting a perspective view of a seal component/housing assembly including the seal component of FIGS. 2-4 and a housing structure.

FIG. 6 is a schematic diagram depicting a perspective cross-sectional view of a portion of the seal component/housing assembly of FIG. 5.

FIG. 7 is a schematic diagram depicting a perspective view of a shaft seal assembly including the seal component/housing assembly of FIGS. 5-6 and a cap structure.

FIG. 8 is a schematic diagram depicting a cross-sectional view of a portion of the shaft seal assembly of FIG. 7.

FIG. 9 is a schematic diagram depicting a perspective view of a seal component for use in a shaft seal assembly containing a twist lock retention feature in accordance with embodiments of the present invention.

FIG. 10 is a schematic diagram depicting a bottom view of an application housing structure for use in a shaft seal assembly containing a twist lock retention feature in accordance with embodiments of the present invention.

FIG. 11 is a schematic diagram depicting a top view of the application housing structure of FIG. 10.

FIG. 12 is a schematic diagram depicting a top perspective view of a shaft seal assembly containing a twist lock retention feature in accordance with embodiments of the present invention.

FIG. 13 is a schematic diagram depicting a side cross-sectional view of a portion of the shaft seal assembly of FIG. 12.

FIG. 14 is a schematic diagram depicting a bottom perspective view of a shaft seal assembly containing a twist lock retention feature in accordance with embodiments of the present invention.

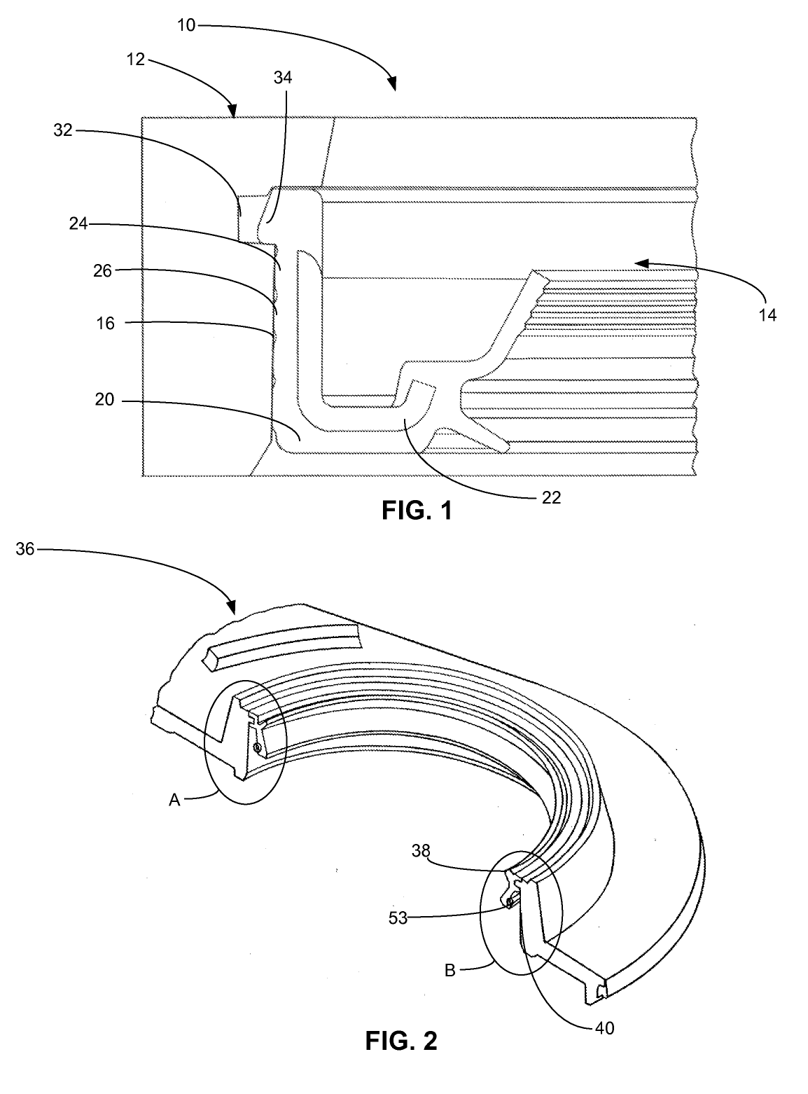

### DETAILED DESCRIPTION

Embodiments of the present invention will now be described with reference to the drawings, wherein like reference numerals are used to refer to like elements throughout. It will be understood that the figures are not necessarily to scale.

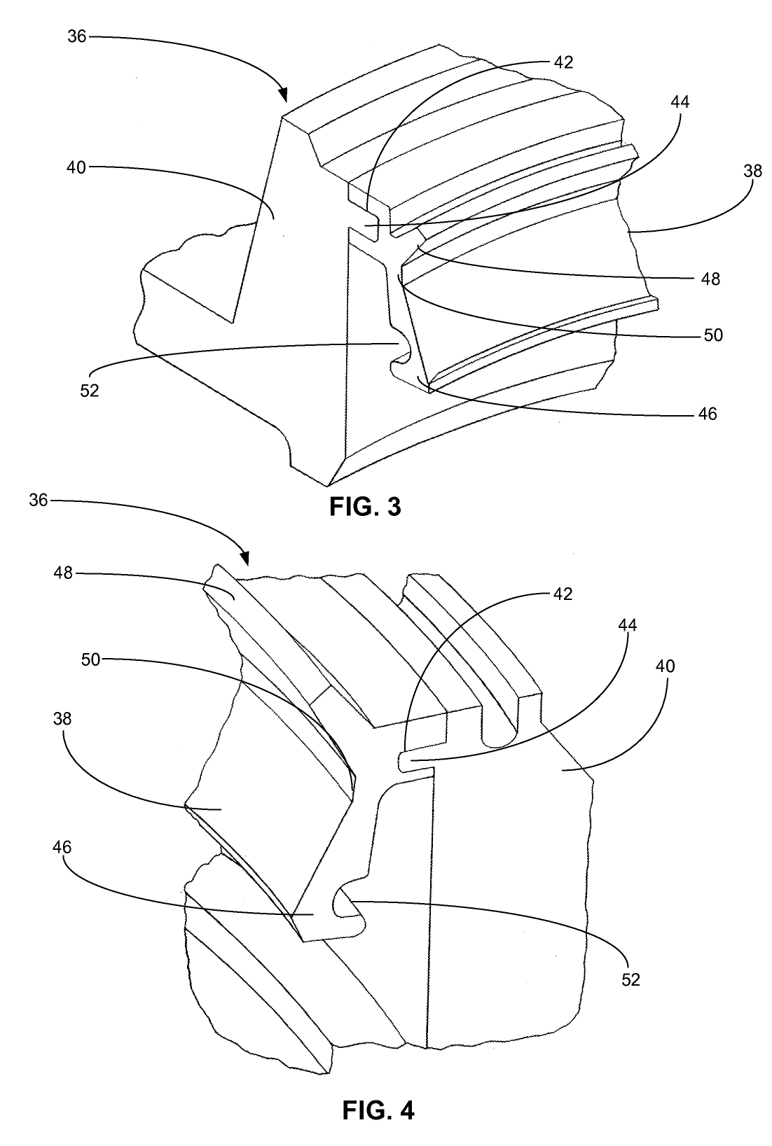

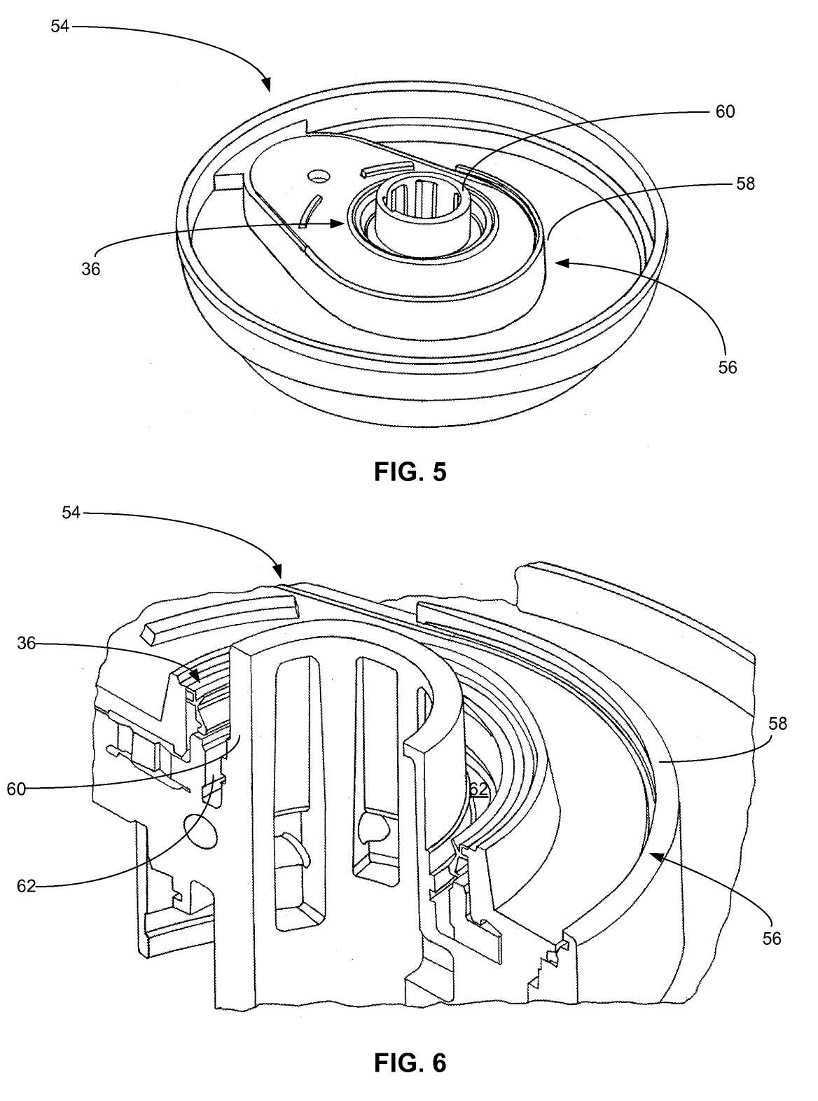

An exemplary embodiment of an enhanced seal component is depicted in FIGS. 2-4, in which like structures are identified by common reference numerals. FIG. 2 is a schematic diagram depicting a perspective view of a portion of a seal component for use in a shaft seal assembly with an over-molded configuration. FIG. 3 is a schematic diagram depicting a perspective cross-sectional view of a portion of a seal component of FIG. 2 identified by the oval A, and FIG. 4 is a schematic diagram depicting a perspective cross-sectional view of a portion of a seal component of FIG. 2 identified by the oval B.

FIGS. 2-4 depict a seal component 36 with an over-molded configuration for use in a shaft seal assembly. The seal component may extend circumferentially substantially to form a ring structure such as may be employed, for example, in a front crank shaft seal and like applications as referenced above. The seal component 36 includes an elastomeric element 38 over-molded onto a substrate 40. The elastomeric element 38 may be made of suitable flexible materials that are used in various shaft seal applications. Suitable materials include, for example, various fluoro-elastomers, poly-acrylic materials, ethylene-acrylic materials, and like materials that are suitable to withstand the exposure to high pressures and extreme temperatures of typical applications. The substrate 40 may be made of suitable more rigid or semi-rigid materials that also are used in various shaft seal applications. The substrate 40 may be formed of rigid or semi-rigid plastic or metal materials, and acts as a stiffener element for controlling in part the degree of compressibility of the elastomeric element 38. For front crank shaft seals, rigid nylon-based plastic materials commonly are employed for the substrate.

Referring more specifically to the close-up views depicted in FIGS. 3 and 4, to provide an over-molded configuration, the elastomeric element 38 defines an over-molding recess 42, and the substrate 40 includes an over-molding extension 44. The over-molding recess 42 receives the over-molding extension 44. In this manner, although the elastomeric element 38 is compressible, the substrate 40 via the over-molding extension 44 acts as a stiffener element for controlling in part the degree of compressibility of the surrounding elastomeric element 38.

As part of the manufacturing of the seal component 36, therefore, the elastomeric element 38 is over-molded onto the substrate 40 and chemically bonded where the over-molding recess 42 receives the over-molding extension 44. The chemical bonding may be aided by a heat-activated adhesive material that bonds the over-molding recess 42 of the elastomeric element 38 to the over-molding extension 44 of the substrate 40. This over-molding of the elastic material over an extension portion of the substrate provides for enhanced seal performance as compared to conventional configurations for incorporation of stiffening elements into the elastomeric material.

The elastomeric element 38 of the seal component 36 is configured to provide an energized seal with a cooperating housing structure to form a complete shaft seal assembly. As seen best with reference to the close-up views of FIGS. 3 and 4, the elastomeric element 38 includes a pair of flexible arms 46 and 48. The flexible arms 46 and 48 may be connected about an apex 50 adjacent the over-molding recess 42 so as to form a substantially “V” or “U” shaped configuration. With such configuration, the arms 46 and 48 generally are compressible about the apex 50 toward the substrate 40 so as to provide an energizing effect. In exemplary embodiments, at least one of the arms (see, for example, arm 48 of FIG. 2) may define a spring recess 52. The spring recess 52 is configured to receive a spring 53 shown specifically in FIG. 2, (not shown in FIGS. 3 and 4) for providing an enhanced energizing effect.

FIG. 5 is a schematic diagram depicting a perspective view of a seal component/housing assembly 54, including the seal component 36 of FIGS. 2-4 and a housing structure 56. FIG. 6 is a schematic diagram depicting a perspective cross-sectional view of a portion of the seal component/housing assembly of FIG. 5. The assembly may, for example, form part of a front crank shaft structure and like applications as referenced above.

The housing structure 56 may have a variety of configurations. In the particular example of FIGS. 5 and 6, the housing structure 56 includes an outer housing component 58 to which the seal component 36 is fixedly attached. The seal components may be fixed by any suitable means, such as adhesives, mechanical fastening, and the like. The housing structure 56 also may have an inner housing component 60, which in the example of FIGS. 5 and 6 is a central cylindrical element that rises above the remaining portions of the housing structure. As best seen in the cross-sectional view of FIG. 6, a gap 62 is present between the seal component 36 and the inner housing component 60. As further explained below, the gap 62 is configured to receive a cap structure that extends over at least a portion of the housing structure 56.

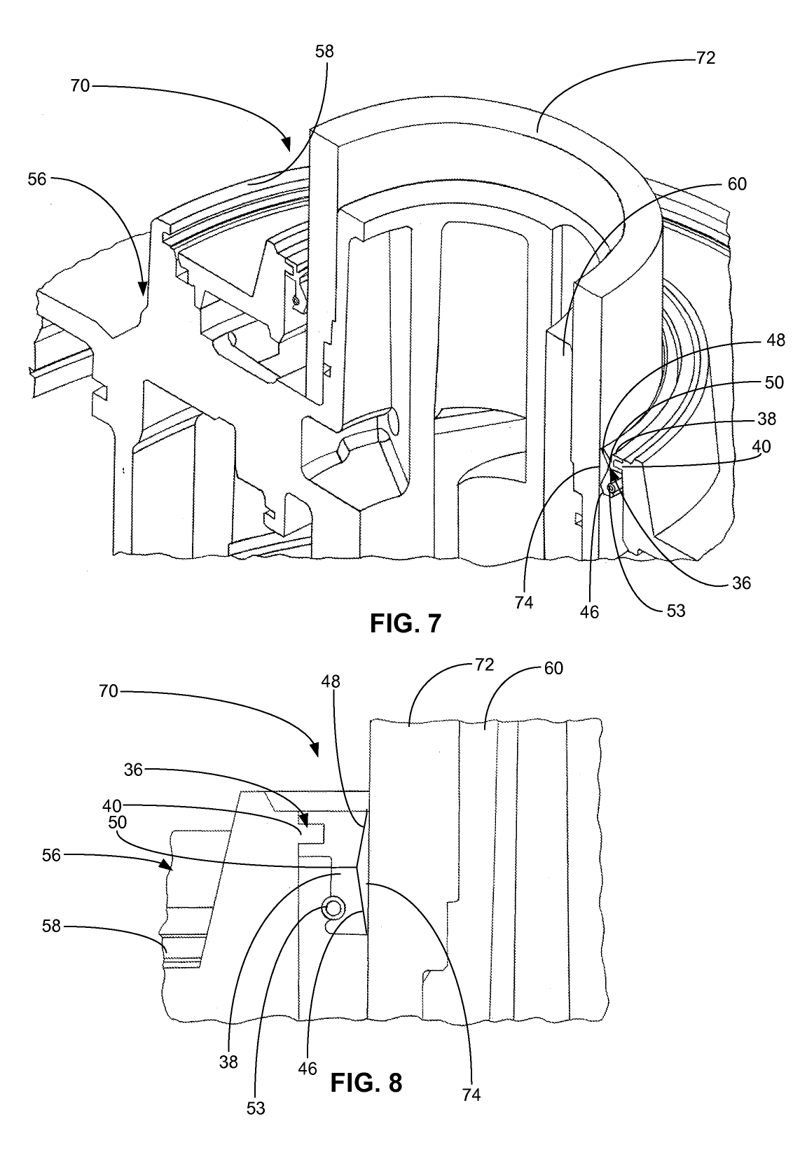

FIG. 7 is a schematic diagram depicting a perspective view of a shaft seal assembly 70 including the seal component/housing assembly of FIGS. 5-6 and a cap structure 72. FIG. 8 is a schematic diagram depicting a cross-sectional view of a portion of the shaft seal assembly 70 of FIG. 7. The shaft seal assembly 70 includes the seal component 36 and the housing structure 56. The cap structure 72 is received in the gap between the seal component 36 and the inner housing component 60 of the housing structure 56. In this manner, the seal component 36 provides a seal between the cap structure 72 and the outer housing component 58 of the housing structure 56. The cap structure then extends over at least a portion of the housing structure.

The seal is generated as follows. As referenced above, the seal component 36 includes the elastomeric element 38 over-molded onto the rigid or semi-rigid substrate 40. The elastomeric element 38 of the seal component 36 is configured to provide an energized seal against an outer face 74 of the cap structure in the complete shaft seal assembly. In the assembled configuration, the arms 46 and 48 of the seal component are compressed about the apex 50 toward the substrate 40 so as to be energized against the outer face 74 of the cap structure 72, so as to provide an energizing effect against the cap structure. As the seal is compressed further, the spring 53 also may become compressed between the elastomeric element and the substrate for providing a further enhanced energizing effect of the seal. The over-molding of the elastomeric element 38 onto the substrate 40 provides an enhanced seal effect by providing an appropriate balance between seal compressibility with some rigidity to strengthen the overall seal integrity.

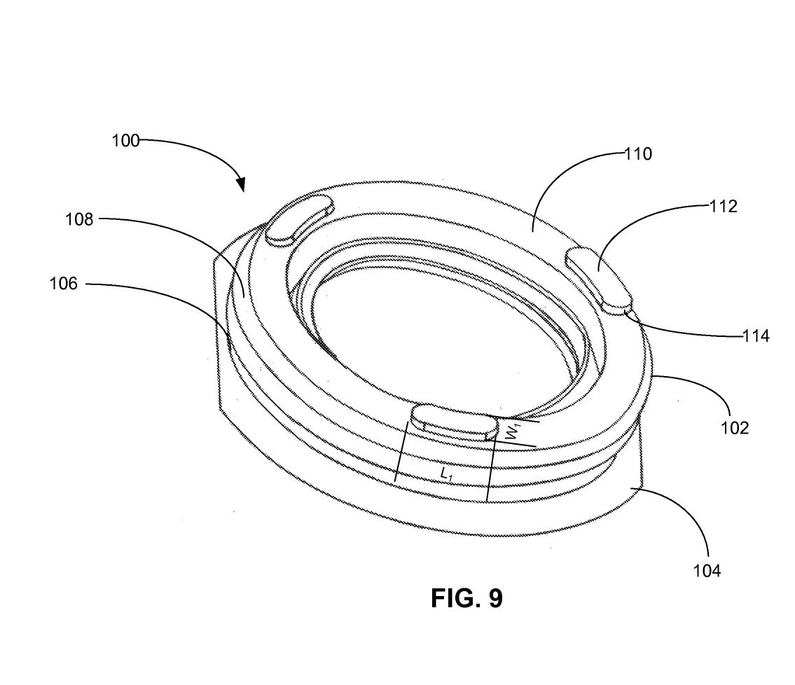

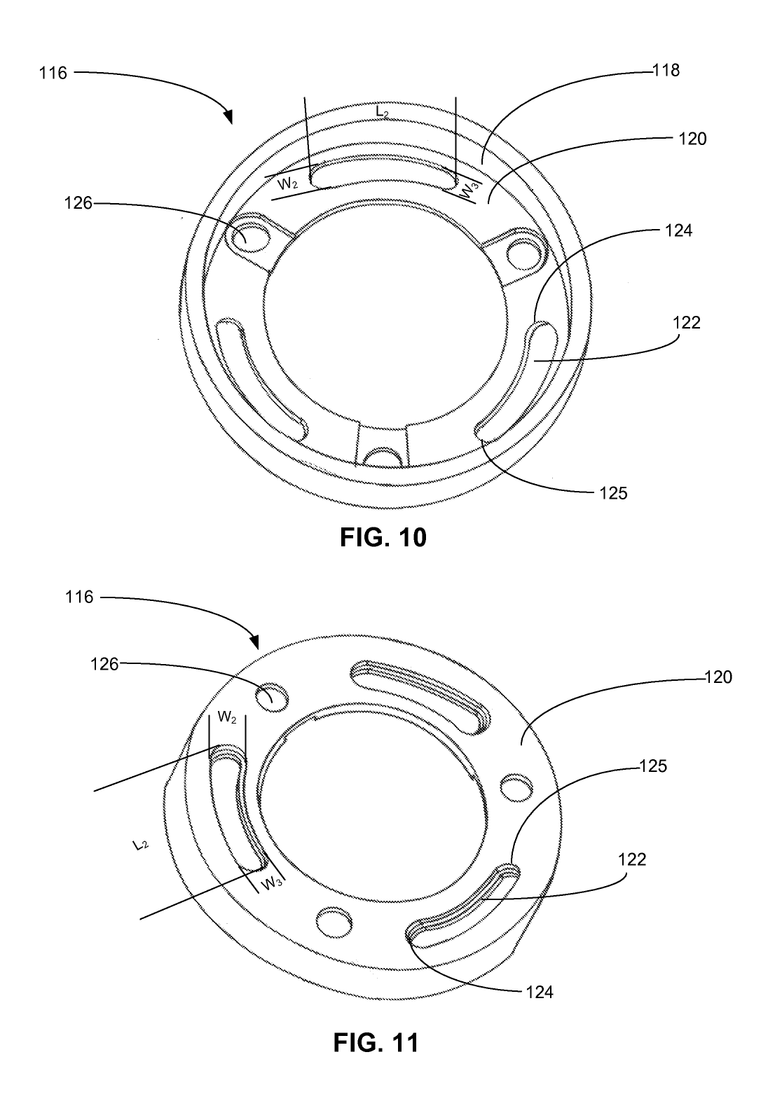

FIGS. 9-14 depict an alternative embodiment of a shaft seal configuration, which also is suitable, for example, for front crank shafts seals and like applications. In the embodiment of FIGS. 9-14, a specialized retention feature is provided in the form of a twist lock retention feature. Similarly to the above, the twist lock retention feature avoids the need for an undercut to be machined in the application housing.

FIG. 9 is a schematic diagram depicting a perspective view of a seal component 100 for use in a shaft seal assembly containing a twist lock retention feature. As further detailed below, the seal component includes an elastomeric element that has a plurality of twist lock retention locking features configured to be received in a portion of a housing structure of the shaft seal assembly, wherein when the seal component is rotated relative to the housing structure from an initial position to a second locked position, the locking features are retained within the receiving portions of the housing structure in the second locked position.

The seal component 100 includes an elastomeric element 102 bonded to a substrate 104. The elastomeric element 102 may be made of suitable flexible materials similarly to the elastomeric element 38 above. Suitable materials include, for example, various fluoro-elastomers, poly-acrylic materials, ethylene-acrylic materials, and like materials that are suitable to withstand the exposure to high pressures and extreme temperatures of typical applications. Similarly, the substrate 104 may be made of suitable more rigid or semi-rigid materials comparably to the substrate 40 above. The substrate 104 may be formed of rigid or semi-rigid plastic or metal materials (steel for example), and acts as a stiffener element for controlling in part the degree of compressibility of the surrounding elastomeric element 102. For front crank shaft seals, rigid nylon-based plastic materials commonly are employed for the substrate.

Similarly to the previous embodiment, the elastomeric element 102 is over-molded onto the substrate 104. In exemplary embodiments, in the over-molding process the elastomeric element 102 may be chemically bonded to the substrate 104. A suitable chemical bond may be achieved by employing a heat-activated adhesive material as are known in the art. The seal component 100 may be formed by a co-molding process in which the components 102 and 104 are molded in a unitary process with the heat-activated adhesive. The chemical bond in the embodiment of FIG. 9 is enhanced by the over-molding of the elastomeric element 102 onto the substrate 104, similarly to the over-molding described as to the seal component of FIGS. 2-4.

As seen in FIG. 9, the elastomeric element 102 has an outer diameter 106 onto which there are formed a plurality of rib structures 108. As further explained below, the seal component 100 including the elastomeric element 102 in part is held against or within an internal bore defined by an application housing structure of the shaft seal assembly, particularly by the frictional forces of the rib structures 108 against such internal bore of an inner diameter surface of the application housing structure (not shown in FIG. 9).

Referring again to FIG. 9, the elastomeric element 102 further includes a top face 110 having thereon a plurality of locking features 112. In the example of FIG. 9, each locking feature 112 is an elongated ridge that extends above the top face 110. Each locking feature has a curvature that substantially follows the curvature of the ring configuration of the elastomeric element 102, and has two opposite rounded ends 114 spaced apart by a first length L₁, and a first uncompressed width W₁ that is associated with the locking mechanism. As further explained below, when the seal component is rotated relative to the housing structure from the initial position to the second locked position, the elongated ridges are compressed within the receiving portions of the housing structure in the second locked position.

It will be appreciated that the precise shape of the locking features may be varied. In addition, the example elastomeric element 102 of FIG. 9 includes three locking features 112 spaced equidistantly about the circumference of the elastomeric element, although the precise number and spacing of the locking features also may be varied.

FIG. 10 is a schematic diagram depicting a bottom view of an application housing structure 116 for use with the seal component 100 in a shaft seal assembly containing a twist lock retention feature. FIG. 11 is a schematic diagram depicting a top view of the application housing structure of FIG. 10. As explained in more detail below, the locking features of the seal component 100 are configured to be received in a portion of the housing structure 116 in an initial position and a second locked position. When the seal component is rotated relative to the housing structure from the initial position to the second locked position, the locking features are retained within the receiving portions of the housing structure in the second locked position.

The application housing structure 116 has a ring structure that is configured to fit over the elastomeric element 102 of the seal component 100 in a manner comparable to a cap configuration. The application housing structure 116 defines an internal bore 118 (see FIG. 10) that is configured to receive the rib structures 108 of the elastomeric element 102 as referenced above. As also referenced above, conventional shaft seal configurations additionally may include an undercut precisely machined into the application housing for a retention feature, but the twist lock retention feature of the current invention avoids the need for such undercut.

The application housing structure 116 is formed of a rigid or semi-rigid material, such as a rigid or semi-rigid plastic or metal. As referenced above, for front crank shaft seals, rigid nylon-based plastic materials commonly are employed. It is desirable that the material used to form the application housing structure is the same as or similar to the material used for the substrate 104 of the seal component 100. In this manner, thermal expansion rates of the application housing structure and substrate of the seal component will substantially match, which aids in maintaining the integrity of the seal.

The application housing structure 116 further includes a top face 120 that has a plurality of locking slots 122. The locking slots 122 are of a number that equals the number of locking features 112 of the elastomeric element 102. The locking slots 122 also are positioned about the top face of the application housing structure such that each locking slot 122 is configured to receive a corresponding or respective one of the elongated ridge locking features 112. Each locking slot 122 has two opposite rounded first and second ends 124 and 125 spaced apart by a length L₂, which is larger than the length L₁ of the locking features 112. In exemplary embodiments, the length L₂ of the locking slots 122 is approximately twice the length L₁ of the locking features 112. When the seal component is rotated relative to the housing structure from the initial position to the second locked position, the elongated ridge locking features move within the respective locking slots along the second length and are compressed within the locking slots of the housing structure in the second locked position.

The application housing structure also may include additional holes 126 for fluid flow, such as for oil or other lubricant materials, and draining.

As part of the twist lock retention feature, the width of each locking slot 122 gradually decreases from the first end 124 toward the second end 125. In particular, each locking slot has a second width W₂ in the vicinity of the first end 124, and decreases to a third width W₃ in the vicinity of the second end 125. In addition, relative to the first uncompressed width W₁ of the locking features 112, the three widths are slightly varied and satisfy the relationship W₃<W₁<W₂.

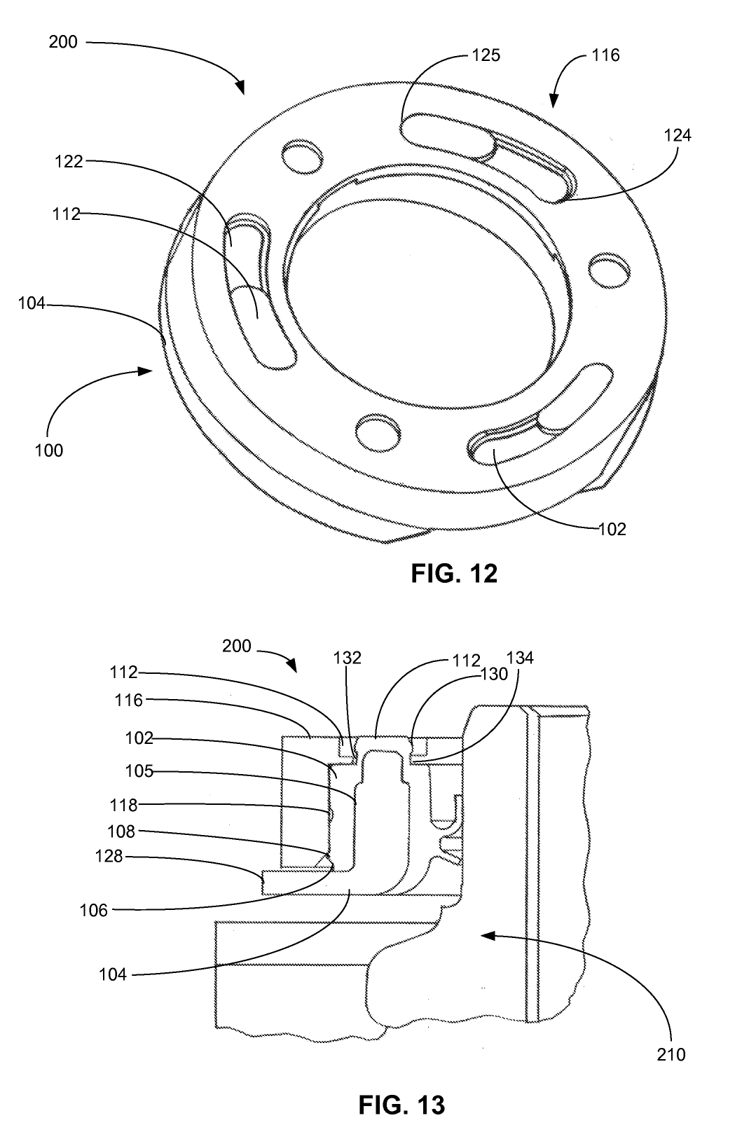

The varying widths provide for the twist lock retention feature as follows. FIG. 12 is a schematic diagram depicting a top perspective view of a shaft seal assembly 200 containing a twist lock retention feature. FIG. 12 depicts the seal component 100, including the elastomeric component 102 and substrate 104, positioned within the application housing structure 116. Like features are labeled the same in FIG. 12 as in the previous FIGS. 9-11. Reference is made to all FIGS. 9-12 in demonstrating the basic mechanism of the twist lock retention feature.

During assembly of the shaft seal assembly 200, the application housing structure 116 is placed over the seal component 100 in a manner such that the rib structures 108 of the elastomeric component 102 are compressed within the internal bore 118 to provide a frictional force between the rib structures and the internal bore. In addition, each elongated ridge locking feature 112 is positioned within a respective locking slot 122 in the first end 124 of such respective locking slot. This position is referred to as an initial or unlocked position. Because the second width W₂ of first end 124 of the locking slot is greater than the first uncompressed width W₁ of the locking feature 112, the locking feature 112 fits readily within the locking slot 122 in a relatively loose or unlocked manner. Then, seal component 100 is rotated, i.e., twisted, relative to the housing structure 116 (the motion is relative, so it does not matter which component actually moves) such that the elongated ridge locking features 112 move within the locking slots 122 along the greater second length L₂ of the locking slots until each locking feature 112 is positioned within a respective locking slot 122 in the corresponding second end 125. This position is referred to as a second or locked position. Because the third width W₃ of the second end 125 of the locking slot is less than the first uncompressed width W₁ of the locking feature 112, the relative motion of the rotation or twisting action compresses each locking feature 112 as each locking feature moves along length L₂ into the smaller width region of the each respective locking slot 122. In this manner, the locking features 112 are compressed and fit tightly within the locking slots 112 in the second position in a locked manner. FIG. 12 specifically depicts the shaft seal assembly 200 in the locked position in which the locking features are compressed within the second ends 125 of the corresponding locking slots 122. In the initial or unlocked position, the locking features 112 would be adjacent the first ends 124 of the corresponding locking slots 122.

FIG. 13 is a schematic diagram depicting a side cross-sectional view of a portion of the shaft seal assembly 200 of FIG. 12, as the shaft seal assembly would be configured within an application assembly 210. The application assembly 210, for example, may be a portion of an engine assembly or other suitable application in which the shaft seal assembly 200 may be used.

As seen in FIG. 13, the substrate 104 has a plurality of extension portions 105 (one is shown in the cross-section view of FIG. 13), and each of the plurality of the extension portions 105 extends into the elastomeric component 102, and particularly extends into an internal recess defined by a respective one of the plurality of locking features 112. In this manner, although the elastomeric component 102 is compressible, similarly to the previous embodiment, the substrate 104 acts as a stiffener element for controlling in part the degree of compressibility of the surrounding elastomeric element 102.

As part of the manufacturing of the seal component 100, therefore, as referenced above the elastomeric component 102 is over-molded substrate 104 and chemically bonded as described above. As part of such over-molding process, the elastomeric material is co-molded over the extension portions 105. The bonding may be aided by a heat-activated adhesive material that bonds the elastomeric component 102 to the extension portion 105 of the substrate 104. This over-molding of the elastic material over an extension portion of the substrate provides for enhanced seal performance as compared to conventional configuration for incorporation of stiffening elements into the elastomeric material.

The substrate 104 also may have at least one flange 128 (which may be a plurality of flanges 128, although only one is seen in the cross-section view of FIG. 13) that extends laterally from a bottom surface the substrate 104 of the seal component 100. As further explained below, the flange 128 has a contact surface that is configured to prevent further rotation beyond the second locked position.

FIG. 13 further depicts the outer diameter 106 of the elastomeric element 102 containing the plurality of rib structures 108. As referenced above, seal retention is aided in part by the frictional forces of the rib structures 108 that are compressed within or against the internal bore 118 of application housing structure 116. Similarly to the previous embodiment, two rib structures 118 are included with significantly larger contours than is conventional, although the precise number and shape may be varied. This results in the seal component 100 having an increased volume of compressible material as compared to the conventional configurations. Again, this added compressibility requires fewer rib structures for retaining the seal component within the bore, and also aids the twist lock retention features in securing the seal components.

Referring again to FIG. 13, each locking feature 112 has opposite sides 130 that may define concave recesses 132. The locking slots 122 of the application housing structure 116 further may include ridges 134 that are configured to be received within the concave recesses 132. The cooperation of the concave recesses 132 and ridges 134 further enhances the integrity of the twist lock retention mechanism.

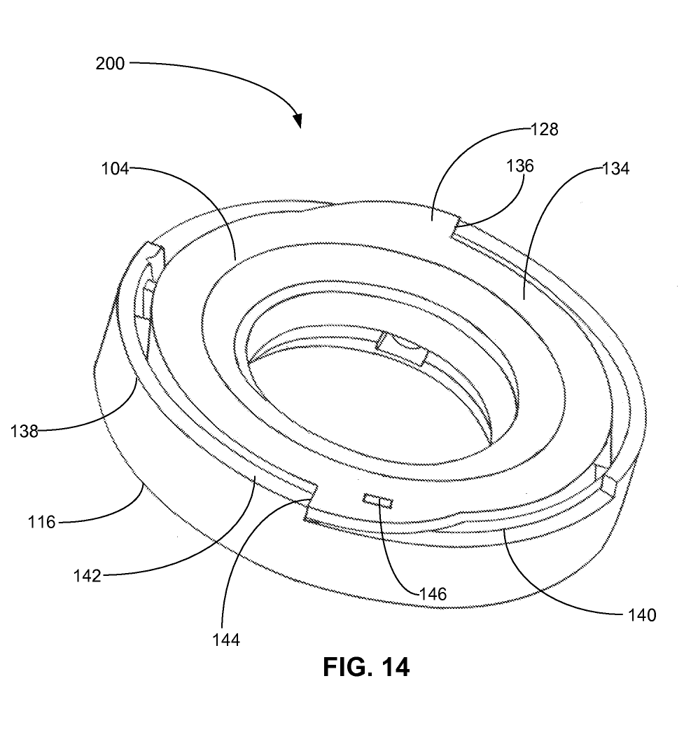

FIG. 14 is a schematic diagram depicting a bottom perspective view of the shaft seal assembly 200 of FIGS. 12 and 13, containing the described twist lock retention feature. As seen in FIG. 14, the plurality of flanges 128 referenced above each is contiguous or extends from a bottom surface 134 of the substrate 104. In addition, the plurality of flanges 108 each includes a contact surface 136. The application housing structure 116 also has a bottom surface 138 that has at least one, or a plurality of, rotation recesses 140 spaced apart from and defined by at least one or a plurality of walls 142. Each wall 142 ends in a blocking surface 144. As seen in FIG. 14, as the seal component is rotated relative to the application housing structure (or vice versa) from the initial unlocked position to the second locked position, each flange 128 moves within a respective rotation recess 140. In the second locked position, which is the position depicted in FIG. 14, a contact surface 136 of each flange is pressed against a blocking surface 144 of a respective wall 142. Further rotation beyond the second locked position is thus prevented by the contact surfaces reaching the blocking surfaces, which prevents over-torque of the shaft seal assembly 200 that otherwise could damage the seal components. The substrate 104 also may include at least one installation hole 146 for receiving an installation tool, such as a ratchet or like tool to facilitate installation.

The described twist lock retention feature provides an enhanced shaft seal structure as compared to conventional configurations. The components are readily molded and assembled, and provide effective seal retention without the need for a precisely machined undercut within the bore of the application housing structure. The described twist lock retention feature thus provides better retention with more simply manufactured components as compared to conventional shaft seals.

As referenced above, in the embodiments incorporating the twist lock retention features, the seal component 100 is formed by over-molding the elastomeric element 102 onto the substrate 104 to chemically bond the elastomeric material to the substrate. Comparable over-molding configurations may be employed in other embodiments of shaft seal assemblies.

In accordance with the above features, an aspect of the invention is a seal component for a shaft seal assembly. In an exemplary embodiment, the seal component includes an elastomeric element and a substrate. The seal component has an over-molded configuration in which the elastomeric element is over-molded onto the substrate.

In another exemplary embodiment of the seal component, the elastomeric element defines an over-molding recess, and the substrate includes an over-molding extension. In the over-molded configuration, the over-molding recess receives the over-molding extension.

In another exemplary embodiment of the seal component, the elastomeric material includes a pair of flexible arms that are compressible about an apex adjacent the over-molding recess.

In another exemplary embodiment of the seal component, at least one of the flexible arms defines a spring recess configured to receive a spring.

Another aspect of the invention is a shaft seal assembly. In an exemplary embodiment, the shaft seal assembly includes the described seal component with an over-molded configuration and a housing structure. The housing structure receives the seal component, and a cap structure extends over at least a portion of the housing structure. The seal component provides a seal between the cap structure and the housing structure.

In another exemplary embodiment of the shaft seal assembly, the flexible arms of the seal component are compressed about the apex toward the substrate so as to energize the seal component against an outer face of the cap structure.

In another exemplary embodiment of the shaft seal assembly, the spring of the seal component is compressed between the elastomeric element and the substrate so as to energize the seal component against an outer face of the cap structure.

Another aspect of the invention is a second seal component for a shaft seal assembly. In an exemplary embodiment, the seal component includes an elastomeric element that has a plurality of twist lock retention locking features configured to be received in a portion of a housing structure of the shaft seal assembly. When the seal component is rotated relative to the housing structure from an initial position to a second locked position, the locking features are retained within the receiving portions of the housing structure in the second locked position.

In another exemplary embodiment of the seal component, the elastomeric element has a top face, and the plurality of locking features each includes an elongated ridge that extends above the top face, wherein when the seal component is rotated relative to the housing structure from the initial position to the second locked position, the elongated ridges are compressed within the receiving portions of the housing structure in the second locked position.

In another exemplary embodiment of the seal component, the seal component has an outer diameter that includes a plurality of rib structures, wherein the rib structures provide a frictional force against an internal bore defined by the housing structure.

In another exemplary embodiment of the seal component, the seal component further includes a bottom substrate that is bonded to a bottom surface of the elastomeric component.

In another exemplary embodiment of the seal component, the substrate includes a plurality of extension portions, wherein each extension portion extends into an internal recess defined by a respective one of the plurality of locking features.

In another exemplary embodiment of the seal component, the substrate has at least one flange that extends laterally from a bottom surface of the substrate, and the flange has a contact surface configured to prevent further rotation beyond the second locked position.

Another aspect of the invention is a second shaft seal assembly. In an exemplary embodiment, the shaft seal assembly includes an elastomeric element that has a plurality of twist lock retention locking features, and a housing structure. The locking features are configured to be received in a portion of the housing structure in an initial position and second locked position, and when the seal component is rotated relative to the housing structure from the initial position to the second locked position, the locking features are retained within the receiving portions of the housing structure in the second locked position.

In another exemplary embodiment of the shaft seal assembly, the elastomeric element has a top face, and the plurality of locking features each includes an elongated ridge that extends above the top face and has a first length. The housing structure has a top face including a plurality of locking slots having a second length longer than the first length, the locking slots each being configured to receive a respective elongated ridge. When the seal component is rotated relative to the housing structure from the initial position to the second locked position, the elongated ridges move within the respective locking slots along the second length and are compressed within the locking slots of the housing structure in the second locked position.

In another exemplary embodiment of the shaft seal assembly, each elongated ridge locking feature has a first uncompressed width W₁, each locking slot has a first end having a second width W₂ and a second end having a third width W₃, and the three widths satisfy the relationship W₃<W₁<W₂. In the initial position each elongated ridge is positioned in the first end of the respective locking slot, and when the seal component is rotated relative to the housing structure from the initial position to the second locked position, the elongated ridges move within the respective locking slots along the second length to the second ends to compress the locking slots of the housing structure in the second locked position.

In another exemplary embodiment of the shaft seal assembly, each locking feature has opposite sides that define concave recesses, and each locking slot includes ridges that are received within the concave recesses of the respective locking feature.

In another exemplary embodiment of the shaft seal assembly, the seal component has an outer diameter that includes a plurality of rib structures, and the housing structure defines an internal bore configured to receive the rib structures. The rib structures provide a frictional force against the internal bore of the housing structure.

In another exemplary embodiment of the shaft seal assembly, the seal component further comprises a bottom substrate that is bonded to a bottom surface of the elastomeric component.

In another exemplary embodiment of the shaft seal assembly, the substrate has at least one flange that extends laterally from a bottom surface of the substrate, the at least one flange having a contact surface, and the housing structure has a bottom surface that has at least one rotation recess space apart from and defined by at least one wall, and each wall ends in a blocking surface. When the seal component is rotated relative to the housing structure from the initial position to the second locked position, each flange moves within a respective rotation such that in the second locked position, the contact surface of each flange is pressed against the blocking surface of the respective wall to prevent further rotation beyond the second locked position.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A seal component for a shaft seal assembly comprising:
an elastomeric element; and
a substrate;
wherein the seal component has an over-molded configuration in which the elastomeric element is over-molded onto the substrate.

2. The seal component of claim 1, wherein:
the elastomeric element defines an over-molding recess;
the substrate includes an over-molding extension; and
in the over-molded configuration, the over-molding recess receives the over-molding extension.

3. The seal component of claim 2, wherein
the elastomeric material includes a pair of flexible arms that are compressible about an apex adjacent the over-molding recess.

4. The seal component of claim 3, wherein at least one of the flexible arms defines a spring recess configured to receive a spring.

5. A shaft seal assembly comprising:
the seal component of claim 1;
a housing structure that receives the seal component; and
a cap structure that extends over at least a portion of the housing structure;
wherein the seal component provides a seal between the cap structure and the housing structure.

6. A shaft seal assembly comprising:
the seal component of claim 3;
a housing structure that receives the seal component; and
a cap structure that extends over at least a portion of the housing structure;
wherein the seal component provides a seal between the cap structure and the housing structure, and the flexible arms of the seal component are compressed about the apex toward the substrate so as to energize the seal component against an outer face of the cap structure.

7. A shaft seal assembly comprising:
the seal component of claim 4;
a housing structure that receives the seal component; and
a cap structure that extends over at least a portion of the housing structure;
wherein the seal component provides a seal between the cap structure and the housing structure, and the spring is compressed between the elastomeric element and the substrate so as to energize the seal component against an outer face of the cap structure.

8. A seal component for a shaft seal assembly comprising:
an elastomeric element that has a plurality of twist lock retention locking features configured to be received in a portion of a housing structure of the shaft seal assembly,
wherein when the seal component is rotated relative to the housing structure from an initial position to a second locked position, the locking features are retained within the receiving portions of the housing structure in the second locked position.

9. The seal component of claim 8, wherein the elastomeric element has a top face, and the plurality of locking features each comprises an elongated ridge that extends above the top face, wherein when the seal component is rotated relative to the housing structure from the initial position to the second locked position, the elongated ridges are compressed within the receiving portions of the housing structure in the second locked position.

10. The seal component of claim 8, wherein the seal component has an outer diameter that includes a plurality of rib structures, wherein the rib structures provide a frictional force against an internal bore defined by the housing structure.

11. The seal component of claim 8, further comprising a bottom substrate that is bonded to a bottom surface of the elastomeric component.

12. The seal component of claim 11, wherein the substrate comprises a plurality of extension portions, wherein each extension portion extends into an internal recess defined by a respective one of the plurality of locking features.

13. The seal component of claim 11, wherein the substrate has at least one flange that extends laterally from a bottom surface of the substrate, and the flange has a contact surface configured to prevent further rotation beyond the second locked position.

14. A shaft seal assembly comprising:
an elastomeric element that has a plurality of twist lock retention locking features; and
a housing structure;
wherein the locking features are configured to be received in a portion of the housing structure in an initial position and second locked position, and
when the seal component is rotated relative to the housing structure from the initial position to the second locked position, the locking features are retained within the receiving portions of the housing structure in the second locked position.

15. The shaft assembly of claim 14, wherein:
the elastomeric element has a top face, and the plurality of locking features each comprises an elongated ridge that extends above the top face and has a first length;
the housing structure has a top face including a plurality of locking slots having a second length longer than the first length, the locking slots each being configured to receive a respective elongated ridge; and
when the seal component is rotated relative to the housing structure from the initial position to the second locked position, the elongated ridges move within the respective locking slots along the second length and are compressed within the locking slots of the housing structure in the second locked position.

16. The shaft assembly of claim 15, wherein:
each elongated ridge locking feature has a first uncompressed width W₁;
each locking slot has a first end having a second width W₂ and a second end having a third width W₃; and
the three widths satisfy the relationship W₃<W₁<W₂;
wherein in the initial position each elongated ridge is positioned in the first end of the respective locking slot, and when the seal component is rotated relative to the housing structure from the initial position to the second locked position, the elongated ridges move within the respective locking slots along the second length to the second ends to compress the locking slots of the housing structure in the second locked position.

17. The shaft seal assembly of claim 16, wherein
each locking feature has opposite sides that define concave recesses; and
each locking slot includes ridges that are received within the concave recesses of the respective locking feature.

18. The shaft seal assembly of claim 14, wherein:
the seal component has an outer diameter that includes a plurality of rib structures; and
the housing structure defines an internal bore configured to receive the rib structures;
wherein the rib structures provide a frictional force against the internal bore of the housing structure.

19. The shaft seal assembly of claim 14, wherein the seal component further comprises a bottom substrate that is bonded to a bottom surface of the elastomeric component.

20. The shaft seal assembly of claim 19, wherein:
the substrate has at least one flange that extends laterally from a bottom surface of the substrate, the at least one flange having a contact surface; and
the housing structure has a bottom surface that has at least one rotation recess apart from and defined by at least one wall, and each wall ends in a blocking surface;
wherein when the seal component is rotated relative to the housing structure from the initial position to the second locked position, each flange moves within a respective rotation such that in the second locked position, the contact surface of each flange is pressed against the blocking surface of the respective wall to prevent further rotation beyond the second locked position.
